(19) United States
(12) Patent Application Publication
(10) Pub. No.: US 2002/0048403 A1
(43) Pub. Date: Apr. 25, 2002

(54) Mark recognition system and method for identification of one or more marks on an object

(75) Inventor: Carl N. Guerreri, Manassas, VA (US)

Correspondence Address: PILLSBURY WINTHROP LLP, 1600 TYSONS BOULEVARD, MCLEAN, VA, 22102, US

(73) Assignee: Electronic Warfare Associates, Inc

(21) Appl. No.: 09/971,632

(22) Filed: Oct. 9, 2001

Related U.S. Application Data
(60) Provisional application No. 60/242,424, filed on Oct. 24, 2000.

(51) Int. Cl. G06K 9/00

(52) U.S. Cl. 382/181

(57) ABSTRACT

A mark recognition system and method are provided for identification of one or more marks on an object. The mark(s) preferably is (are) indicative of the source of the object. The source can be one or any combination of the processor, distributor, manufacturer, and the like. The mark itself can be a touch mark, hallmark, or the like. The mark recognition system comprises an input module, a processor, and an output module. The input module is adapted to receive query image information about at least one mark on an object. The processor is configured to compare the query image information to archived image information about known marks, to determine which one or more items of the archived image information correspond to the query image information. The output module is configured to communicate, to a user, result information indicating which one or more items of the archived image information correspond to the query image information. The mark recognition method comprises receiving query image information about at least one mark on an object, comparing the query image information to archived image information about known marks to determine which one or more items of the archived image information correspond to the query image information, and communicating result information to a user. The result information indicates which one or more items of the archived image information correspond(s) to the query image information. Also provided is a computer-readable medium encoded with a processor-executable instruction sequence for carrying out the mark recognition method.

### BACKGROUND OF THE INVENTION

The present invention relates to a mark recognition system and method for identification of one or more marks on an object.

It is customary in several industries to provide marks on objects produced, distributed, or processed by the various participants in each industry. These marks can be indicative of the source of the objects (e.g., the manufacturer, processor, distributor, or the like), and/or they can be indicative of object characteristics. Examples of such characteristics include the city of origin, the date or year of manufacture or processing, and the purity of the object (e.g., in the case of metals, jewelry, and the like).

The use of such marks is especially prevalent with collectibles. Examples of such collectibles are plates, china, artwork, dolls, metal goods manufactured by craftsmen, and the like. When assessing the value of a collectible or otherwise assessing its history, there is often a need to identify a mark on the object and to determine its source and what other aspects of the object can be gleaned from the mark. In the past, however, there was no comprehensive and convenient way to identify such marks and/or to determine what characteristics of the object can be gleaned from the presence of the mark.

While a manual search could be conducted through different books that contain pictures of known marks and information about the marks, this falls well short of providing a convenient way of identifying marks. Marks with unique shapes/designs are difficult to classify in such a way that a person can quickly find it in any book of substantial size. The search for a matching shape or design in such books therefore can be prohibitively time-consuming and impractical. Moreover, the size of book(s) required in order to encompass large numbers of marks and/or different categories of collectibles or objects would make it far from practical to carry the book(s) to remote places where the collectible might be located. Another problem with such books relates to the difficulty associated with incorporating updated information into the books and/or the expense associated with reprinting updated versions of the book.

There is consequently a need in the art for a convenient system and/or method for recognizing a mark on an object and for providing information about the mark and/or about objects associated with the mark. This need extends to a system and method that performs a comparison between the image of a mark to be recognized and archived images of known marks, and that determines, based on this comparison, which known mark(s) provide the closest match.

### SUMMARY OF THE INVENTION

It is a primary object of the present invention to overcome at least one of the shortcomings, problems, or limitations associated with conventional techniques for identifying marks on object or collectibles.

To achieve this and other objects, the present invention provides a mark recognition system comprising an input module, a processor, and an output module. The input module is adapted to receive query image information about at least one mark on an object. The processor is configured to compare the query image information to archived image information about known marks, to determine which one or more items of the archived image information correspond to the query image information. The output module is configured to communicate, to a user, result information indicating which one or more items of the archived image information correspond to the query image information.

The mark(s) preferably is (are) indicative of the source of the object. The source can be one or any combination of the processor, distributor, manufacturer, and the like. The mark itself can be a touch mark, hallmark, or the like.

Preferably, the system includes or is otherwise associated with at least one database containing the archived image information about the known marks. The database is accessible by the processor.

The archived image information preferably includes a digitized image of each of the known marks, and includes or is otherwise associated with text describing aspects of each known mark and/or aspects of the objects with which the mark is associated. Examples of such text include the name of an object source associated with the known mark, the time period during which the known mark was used by the object source, the geographic area where objects with the known mark were produced or distributed, and a description of objects to which the known mark has been applied.

The input module preferably includes an image capturing device configured to capture an image of the mark(s) to be recognized and to digitize the image to provide a digitized version of the query image information.

Preferably, the processor is configured to determine which one or more items of the archived image information most closely match(es) the query image information, and the output module includes a graphic user interface that is configured to display the query image information and the most closely matching item(s) of the archived image information. This graphic user interface also can be configured so that, when a user selects a displayed one of the items of archived image information, an enlarged version of that displayed item is presented by the graphic user interface to the user simultaneously with, and adjacent to, the query image information.

Preferably, the input module is configured to receive text information about the mark(s) to be recognized. The processor, in this regard, can be configured to limit comparison of the query image information to archived image information about known marks that correspond to this text information. Similarly, the output module can be configured to communicate, to the user, the result information in such a way that it indicates which of the items of the archived image information correspond to the query image information and also to the text information. The result information preferably includes textual information about the known mark(s) (i.e. about the mark(s) associated with the matching item(s) of archived image information).

Preferably, the processor and/or output module are configured to visually emphasize differences, if any, between the query image information and the archived image information associated with matching item(s). The processor and/or output module also can be configured so as to display an enlarged version of a portion of the query image information and the archived image information, in which portion the differences, if any, are present.

Preferably, the input module includes a graphic user interface that is configured to visually display information fields to a user, each information field being selectable by a user to insert textual information about the mark(s) to be recognized.

Also provided by the present invention is a mark recognition method. The mark recognition method comprises receiving query image information about at least one mark on an object, comparing the query image information to archived image information about known marks to determine which one or more items of the archived image information correspond to the query image information, and communicating result information to a user. The result information indicates which one or more items of the archived image information correspond(s) to the query image information.

The present invention also provides a computer-readable medium encoded with a processor-executable instruction sequence for receiving query image information about at least one mark on an object, comparing the query image information to archived image information about known marks to determine which one or more items of the archived image information correspond to the query image information, and communicating result information to a user. The result information indicates which item(s) of the archived image information correspond(s) to the query image information.

Additional features, objects, and advantages will become readily apparent to those having skill in the art upon viewing the following detailed description, the accompanying drawings, and the appended claims.

### BRIEF DESCRIPTION OF THE DRAWINGS

FIG. 1 is a block diagram of a mark recognition system according to a preferred implementation of the present invention.

FIGS. 2-12 illustrate screen display formats according to preferred implementations of the present invention.

FIG. 13 is a flow diagram illustrating a mark recognition method according to a preferred implementation of the present invention.

### DESCRIPTION OF PREFERRED IMPLEMENTATIONS

A preferred embodiment of the present invention will now be described. Although elements of the preferred embodiment are described in terms of a software implementation, the invention may be implemented in software or hardware or firmware, or a combination of two or more of the three. For example, modules or other aspects of the invention may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input data and generating output data.

Suitable processors include, by way of example, both general and special purpose microprocessors. Generally, a processor receives instructions and data from a read-only memory and/or a random access memory. Storage devices suitable for tangibly embodying computer program instructions include, for example, all forms of non-volatile memory, such as semiconductor memory devices (e.g., including EPROM, EEPROM, and flash memory devices), magnetic disks (e.g., internal hard disks and removable disks), magneto-optical disks, and optical disks (e.g., CD-ROM disks). Any of the foregoing may be supplemented by, or incorporated into, specially designed ASICs (application-specific integrated circuits). A computer can generally also receive programs and data from storage medium such as an internal disk or a removable disk. These elements also can be found in the conventional laptop, desktop or workstation computer as well as other computers suitable for executing computer programs implementing the methods, described herein, which may be used in conjunction with any digital print engine or marking engine, display monitor, or other raster output device capable of producing color or gray scale pixels on a paper, a film, a display screen, or any other output medium.

Hereinafter, some aspects of the present invention and its preferred implementations will be described as being “configured to” perform certain functions or processes. It will be appreciated from this disclosure that such a configuration can be achieved using known computer or processor programming techniques, or by otherwise associating the present invention with a processor-executable instruction sequence that, when executed, causes the described functions or processes to be performed.

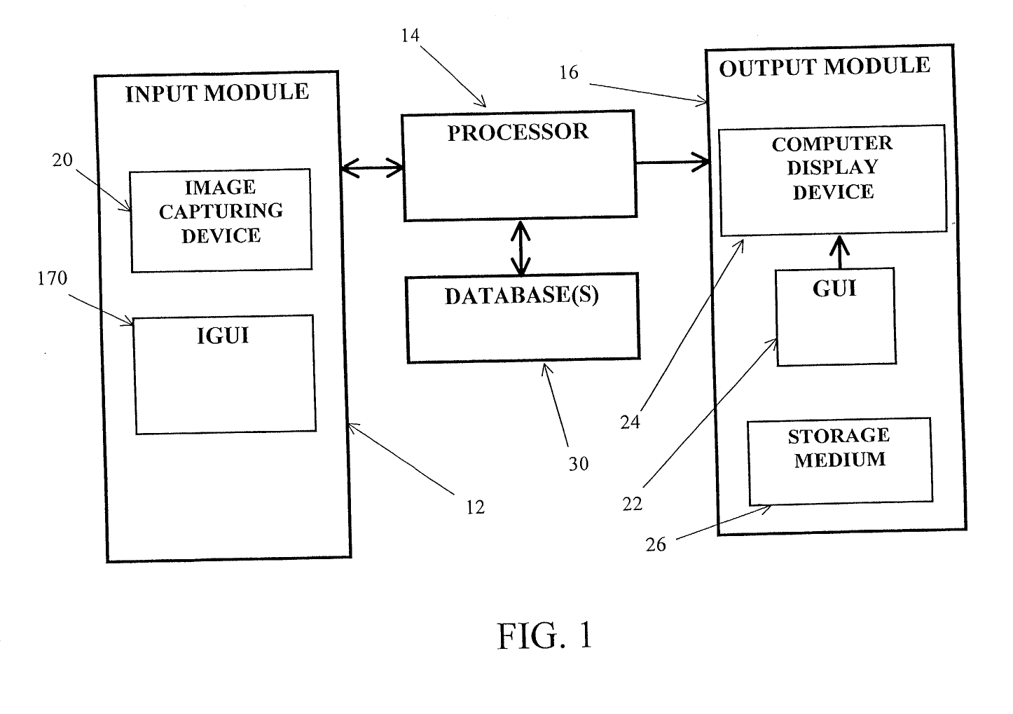

With reference to FIG. 1, according to a preferred implementation of the present invention, a mark recognition system 10 comprises an input module 12, a processor 14, and an output module 16. The input module 12 is adapted to receive query image information about one or more marks on an object. The input module 12 preferably includes an image capturing device 20 configured to capture an image of the mark(s) and to digitize the image to provide a digitized version of the query image information. Examples of known image capturing devices 20 include a scanner adapted to scan an image from a photograph, from a drawing, or from any other rendition of the mark, a digital photography camera, an analog television camera and frame grabber combination, a digital television camera, a microscope equipped with a suitable television camera (i.e. equipped with an analog television camera and frame grabber combination, equipped with a digital camera, or the like) or equipped with a suitable digital camera, an artist/computer-generated rendition of a mark, and the like.

The marks preferably are touch marks, hallmarks, or other marks used by manufacturers, distributors, processors, or other sources of goods to distinguish themselves as the manufacturers, distributors, processors or the like of the particular objects that carry the mark, and/or to identify the city where the objects are produced, the year when the objects were produced, and/or the purity of the objects. The marks can be symbols, alpha-numeric characters, or a combination of alpha-numeric characters and symbols.

The objects preferably are collectibles, such as paintings, sculptures, plates, china, dolls, other forms of artwork, metal goods, jewelry, and the like. While the use of such marks is well known in connection with collectibles, the present invention is not limited to use on such goods. It can be applied to any goods that carry, or otherwise are associated with, identifying marks.

The processor 14 is configured to compare the query image information to archived image information about known marks. The processor 14 can be so configured by suitably programming the processor 14, or otherwise associating the processor 14 with a processor-executable instruction sequence that, when executed, causes the comparison to be made. Based upon this comparison, the processor 14 determines which one or more items of the archived image information correspond to the query image information. The processor 14 thereby is able to determine which known marks correspond to the mark(s) on the object.

The output module 16 is configured to communicate result information to a user. The result information indicates which of the item(s) of the archived image information correspond to the query image information. The user thus is able to readily determine from the output module 16 which known marks correspond to the mark(s) on the object.

Preferably, the processor 14 is configured to determine which one or more of the item(s) of archived image information most closely match(es) the query image information. In doing so, the processor 14 can rank the matches according to how closely the query image information matches each item of archived image information. This ranking can include five or more such items (i.e., the five or more that most closely match the mark(s)) and preferably includes at least ten such items. Alternatively, the present invention can be practiced with fewer items in the ranking. The ranking also can be eliminated in favor of an implementation where the processor 14 merely determines which single one of the items (i.e., the top match) most closely matches the mark(s).

The processor 14 also can be configured to determine which N items provide a closer match than any other items, where N is an integer greater than zero. The integer N more desirably is greater than 5, and preferably is greater than 10. This determination can be made without determining the rank of each such item with respect to the other items within the group of N items.

Preferably, the output module 16 includes a graphic user interface (GUI) 22. The GUI 22 is configured to display the most closely matching item(s) of archived image information. The most closely matching item(s) preferably is (are) displayed simultaneously with, and adjacent to, the query image information.

If the processor 14 is configured, as in the above example, to determine which N items provide the closest match to the query image information (i.e. the closest match to the mark(s)), the GUI 22 can be configured to display the query image information along with the N items of archived image information.

If the processor 14 also is configured to determine which item in the group of N items matches the query image information better than any of the other items in the group (i.e., which item constitutes a best-match item), then the GUI 22 preferably is configured to display the best-match item more prominently than other items in the group of N items. This prominence can be achieved in several different ways. It can be achieved, for example, by providing a larger display of the best-match item and/or by displaying the best-match item closer to a display of the mark(s) that form(s) the subject of the query image information.

The GUI 22 also can be configured to cooperate with the processor 14 such that, when a user selects a displayed one of the item(s), an enlarged version of the selected item(s) is presented by the GUI 22 to the user. This enlarged version preferably is presented simultaneously with, and adjacent to, the query image information. This provides a convenient way for the user to visualize the similarities and differences, if any, between the most closely matching item(s). The selection can be made by “mouse-clicking” on the item or via any other convenient selection device and/or technique.

The processor 14 and/or output module 16 (e.g. including the GUI 22) also can be configured to visually emphasize differences, if any, between the query image information and the archived image information. This is especially desirable when the mark is relatively complex and/or the differences are subtle. By emphasizing the differences for the user, the user is less likely to fail to appreciate these differences. The user also will tend to recognize the differences, if any, more quickly. This generally makes it easier for the user to visually evaluate of the relationship between the items of archived image information and the mark(s) that is (are) the subject of the query image information.

One exemplary way of providing this emphasis is through a highlighting technique. The differing portions can be highlighted in the display of the item(s). In addition, or alternatively, the processor 14 and/or the output module 16 can be configured to display an enlarged version of any differing portion(s) of the query image information and the archived image information. Such enlargement of the differing portion(s) makes it easier for the user to visually identify the differences.

The output module 16 preferably includes (or is otherwise associated with) a computer display device 24 or any other device capable of recording or displaying the result information. Examples of such computer display devices 24 are a computer monitor, a printer, or the like. The most closely matching item(s) and/or other results of the comparison can be displayed by the GUI 22 on the computer display device 24.

In addition, or alternatively, the output module 16 can include, or be associated with, a computer-readable storage medium 26 (e.g., a magnetic disk, optical disk, hard-drive, or the like) where the result information is stored.

Preferably, the mark recognition system 10 includes or is associated with one or more databases 30. The database(s) 30 can be accessed by the processor 14 and contains the archived image information, as well as other information about known marks and/or objects that have been associated with such marks. Preferably, the archived image information includes a digitized image of each of the known marks and is associated with text describing aspects of each known mark and/or describing objects associated with each known mark. The text can include, for example, a name of an object source associated with the known mark, a time period during which the known mark was used by the object source, a geographic area where objects with the known mark were produced or distributed, and/or a description of objects to which the known mark has been applied or has been associated with.

The database(s) 30 of archived image information preferably include(s) many sub-libraries or files containing graphical representations of marks, along with the text information. The database(s) 30 of archived image information also can include images of the objects that carry each mark. These images of the objects can be presented along with, or as part of, the result information.

The database(s) of archived image information can be configured to support relational, hierarchical, and object-oriented searching, as well as other searching techniques. These searching techniques can be used when performing the aforementioned comparison of the query image information to the archived image information. Preferably, the processor 14 is configured to perform these searching techniques.

In addition, or alternatively, the processor 14 can be configured to apply well-known image recognition and/or classifying techniques when comparing the query image information to the archived image information. Exemplary image recognition and/or classifying techniques are disclosed in U.S. Pat. No. 6,014,461 to Hennessey et al.; U.S. Pat. No. 5,960,112 to Lin et al.; U.S. Pat. No. 5,673,338 to Denenberg et al.; U.S. Pat. No. 5,644,765 to Shimura et al.; U.S. Pat. No. 5,521,984 to Denenberg et al.; U.S. Pat. No. 5,555,409 to Leenstra, Sr. et al.; and U.S. Pat. No. 5,303,367 to Leenstra, Sr. et al., the contents of all of which are incorporated herein by reference.

Preferably, the database(s) 30 is (are) expandable to include updates of archived image information and related text information. These updates can be provided by the custodian of the database(s), by third parties, and/or by users of the system 10. The processor 14, in this regard, can be adapted to receive supplemental information (including images and/or text) about the items of archived image information, or about new items of mark-related information that should be incorporated into the database(s) 30 (e.g., supplemental information about new marks, about use of existing marks with new products, and the like). The processor 14 then can suitably incorporate this supplemental information into the relevant database(s) 30.

If the archived image information and/or text information is derived from different sources, it also can include an indication of the source of each item or collection of information. Preferably, the GUI 22 presents this indication to the user, along with the result information. This advantageously allows the user to better judge the reliability of the information based on the reputation of the source.

Preferably, the input module 12 is configured to receive text information about the mark(s) that is (are) the subject of the query image information. The text information can be entered via a keyboard, keypad, touch-screen, virtual keyboard displayed on a screen, one or more drop-down or pop-up menus, a mouse, and/or other suitable text input devices and/or techniques. The text information itself can include, for example, the name of an object source associated with the mark(s), a time period during which the mark(s) was (were) used by the object source, a geographic area where objects with the mark(s) were produced or distributed, and/or a description of objects to which the mark(s) has (have) been applied (e.g., names of the objects, country of origin, materials used to make the object, date of manufacture, and the like).

Preferably, the processor 14 is configured to limit comparison of the query image information to archived image information about known marks that correspond to the text information. For example, if the text information indicates that the subject mark was found on an English silver product crafted during the period between 1780 A.D. and 1800 A.D., the search for items of archived image information can be limited to archived image information corresponding to known marks that were used in conjunction with English silver products crafted between 1780 A.D. and 1800 A.D. Limiting the comparison (i.e., the search) in this manner can conserve processing resources and can greatly expedite the process of finding matching items. To the extent that irrelevant items of archived image information are excluded, it also can improve the accuracy of the result information.

Preferably, the output module 16 and/or the graphic user interface (GUI) 22 are configured to communicate, to the user, the result information indicating which of the items (e.g., known marks) of the archived image information correspond to the query image information and also correspond to the entered text information, if any was entered. The output module 16 and/or the processor 14 also can be configured so that the result information includes textual information about the known mark(s) associated with the corresponding items of archived image information.

The GUI 22 of the output module 16, in this regard, can be configured to display information fields containing items of the text information. Examples of such display information fields include a name field containing the name of an object source associated with the known mark, a time period field that contains an indication of the time period during which the known mark was used by the object source, a geographic area field that contains text information indicating where objects with the known mark were produced or distributed, and/or an object description field that contains a description of objects to which the known mark has been applied or has been associated with. A special information field also can be provided to display information that is relevant but that cannot be classified into one of the display information fields.

The GUI 22 of the output module 16 also can be configured so that the display information fields (i.e., the non-image information) remain suppressed when the result information is initially displayed and are revealed only after a user makes an appropriate selection. This is especially desirable when the GUI 22 of the output module 16 is configured to simultaneously display more than one of the closest matching items of archived image information. Under such circumstances, it may be difficult to fit all of the display information fields for all of the displayed items onto one visual screen display. Excessive cluttering of the initially displayed result information thus can be avoided by initially suppressing the information fields.

When a user then selects one of the displayed items (e.g., using a “mouse-click” or other selection device and/or technique), the system 10 can respond by displaying the display information fields for the selected item of archived image information. Preferably, the previously suppressed display information fields are presented along with an enlarged or otherwise more prominent rendition or image of the mark associated with the selected item of archived image information.

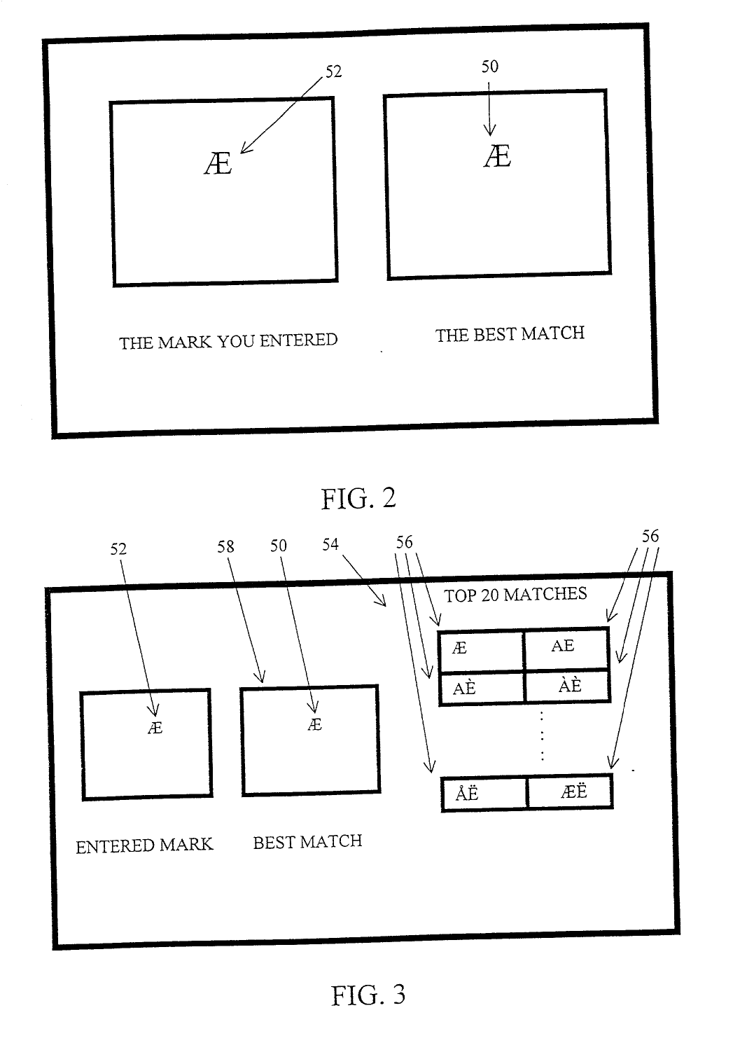

FIGS. 2-12 illustrate exemplary display screen formats that can be generated by the GUI 22 of the output module 16. In FIG. 2, the display screen format includes an image 50 of the closest match displayed next to an image 52 of the mark to be recognized.

FIG. 3, by contrast, shows a display screen format in which an image 52 of the mark to be recognized is displayed along with an array 54 of images of the top 20 closest matches 56. Between this array 54 and the image 52 of the mark to be recognized is a best-match field 58. Preferably, by default, the best-match field 58 initially contains an image 50 of the best-matching item of archived image information. Other images, however, can be selected for display in the best-match field 58. In this regard, the display screen format can be presented in such a way that, when a user selects any other image listed in the array 54, that selected image is enlarged and transferred to fill the best-match field 58. This provides a convenient way to selectively view the images associated with the top 20 closest matches and to visually compare such images to the image 52 that is to be recognized.

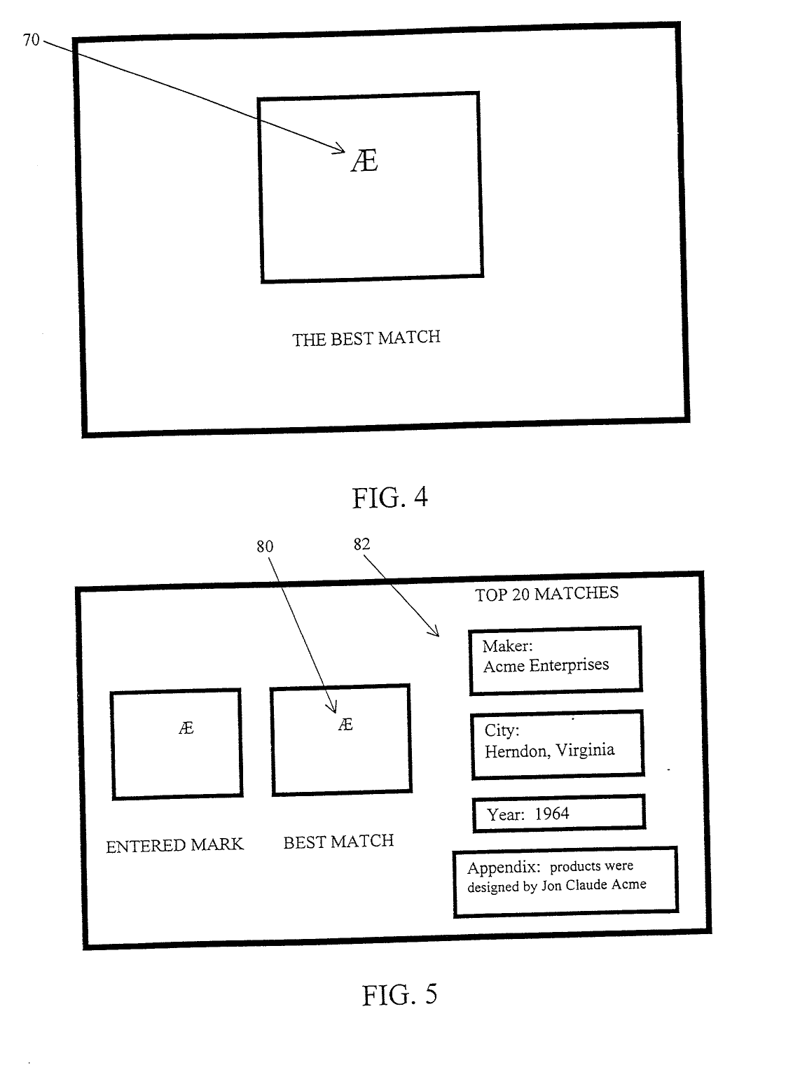

In FIG. 4, a simplified display screen format is illustrated. The display screen format of FIG. 4 contains only an image 70 of the best matching item of archived image information.

FIG. 5 illustrates an augmented version of the simplified display screen shown in FIG. 4. This augmented version, in addition to including an image 80 of the best matching item, also includes text information 82 about the best matching item. The exemplary text information 82 includes the name of a maker of the object, the city where the object is manufactured, the year during which the object was manufactured, and an appendix with additional text information about the object or associated mark.

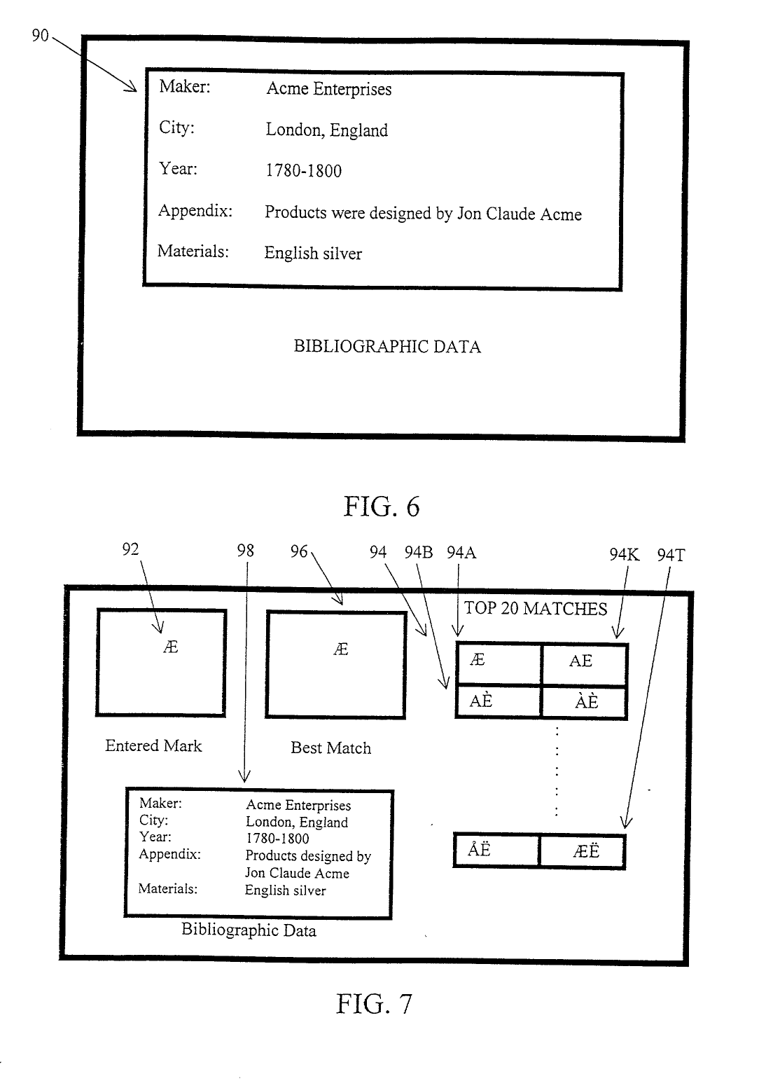

FIG. 6 illustrates an alternative display screen format in which the text information 90 associated with the best matching item of archived image information is shown, without an image of the object or an image of the mark.

FIG. 7 illustrates another more comprehensive display screen format. The display screen format of FIG. 7 includes an image 92 of the mark to be recognized. This image 92 of the mark to be recognized is displayed along with an array 94 of images 94A, 94B . . . 94T of the top 20 closest matches. Between this array 94 and the image 92 of the mark to be recognized is a best-match field 96. Below the best-field match field 96 and the image 92 of the mark to be recognized is a bibliographic data field 98 that contains text information. Preferably, by default, the best-match field 96 and bibliographic data field 98 initially contain the image of the best-matching item of archived image information and the text associated therewith, respectively. Other images also can be displayed in the best-match field 96. In this regard, this exemplary display screen format can be presented in such a way that, when a user selects any other image listed in the array 94, that selected image 94A, 94B, . . . or 94T is enlarged and transferred to fill the best-match field 96. This selection by the user also can be performed in such a way that the text information associated with the selected image is transferred to, and displayed in, the bibliographic data field 98. A convenient way thus is provided for selectively viewing the images 94A, 94B, . . . 94T associated with the top 20 closest matches and visually comparing such images to the image 92 to be recognized, while concurrently viewing the text information associated with the selected mark.

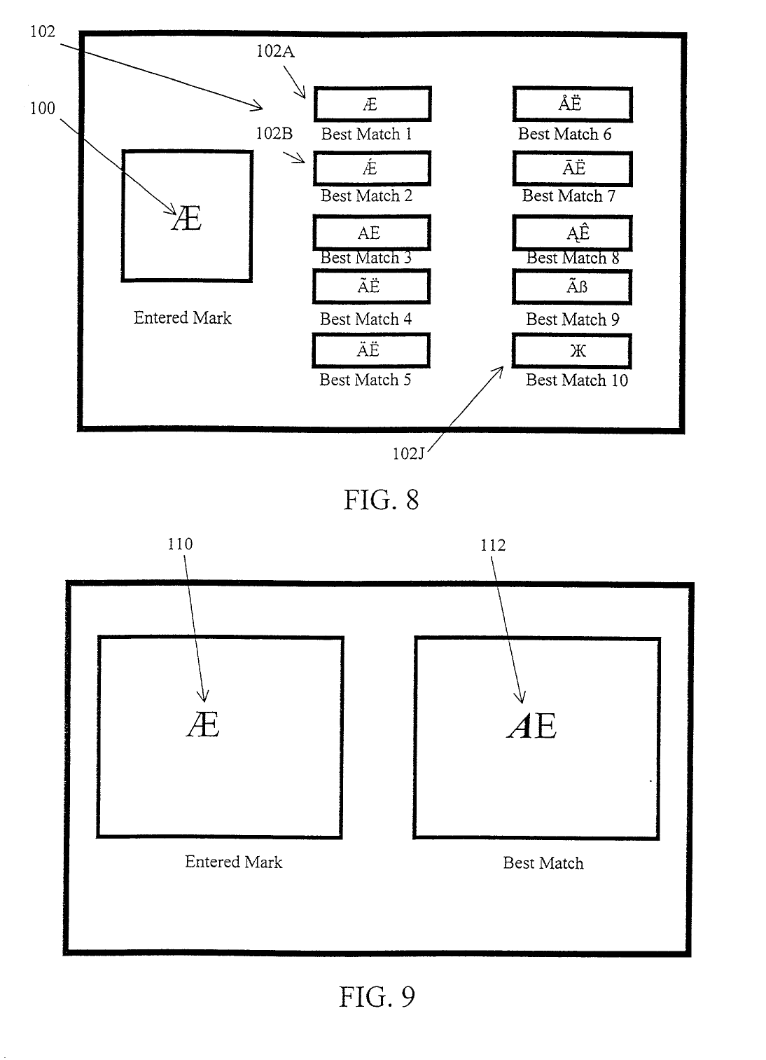

FIG. 8 shows a display screen format that includes an image 100 of the mark to be recognized, as well as an array 102 of images 102A, 102B, . . . 102J of the top ten best matching items of archived image information.

FIG. 9 shows a display screen format that includes an image 110 of the mark to be recognized, as well as a suitably highlighted image 112 of the best matching item of archived image information. The image 112 of the best matching item has been highlighted to emphasize the differences between the best matching item and the image 110 of the mark to be recognized. In this example, the letter “A” appears differently in the respective marks. The highlighting is represented in FIG. 9 using bold type-face. The highlighting can be accomplished by displaying the portions that differ using different colors (e.g., using yellow, red, orange, or other bright colors to signify the differences) or by overlapping a different color over the differing portions. Other highlighting techniques also can be used. The highlighting, also or alternatively, can be used to emphasize the similarities.

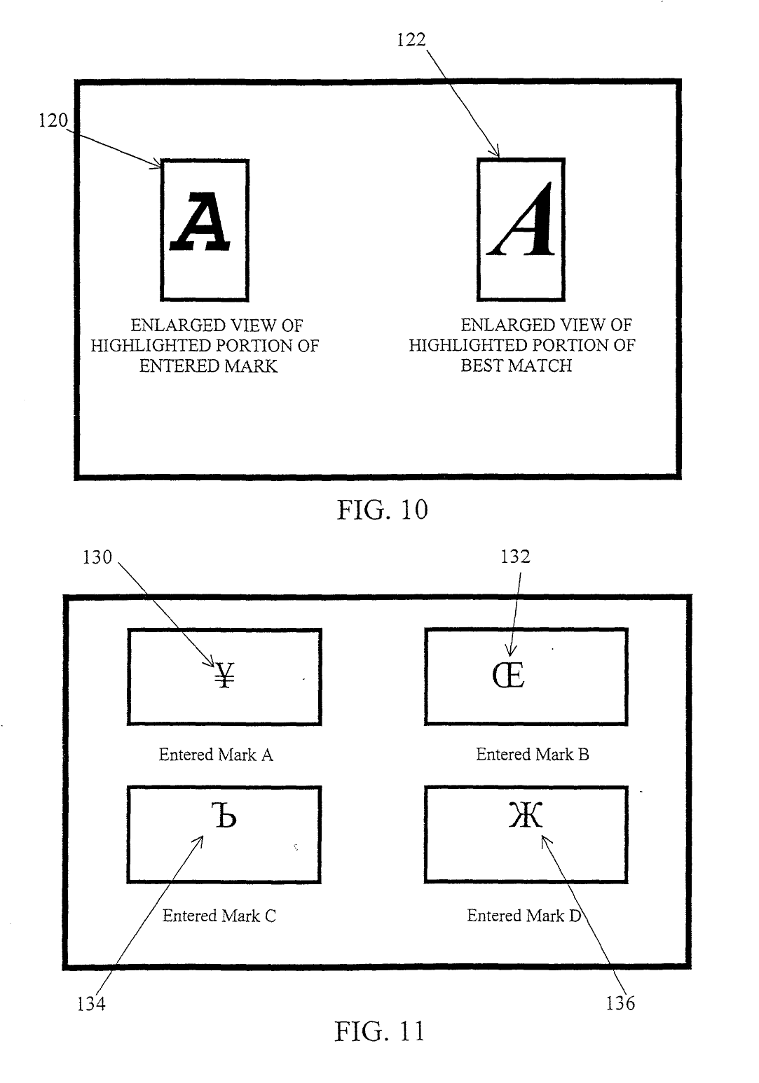

If the system 10 is configured, as indicated above, so that parts of the displayed image of the mark to be recognized and/or parts of the displayed image of the best-matches can be highlighted or otherwise selected for enlargement, then the system 10 also can be configured to provide a display screen format that includes the enlarged parts adjacent to one another. An example of this display screen format is illustrated in FIG. 10.

FIG. 10 shows an enlarged part 120 of the image to be recognized and an enlarged part 122 of the displayed image of the best match. In this exemplary enlargement, the differing portion(s) are being displayed in an enlarged manner, rather than the matching portions. The system 10, however, can be configured so that the matching portion(s) are enlarged, instead of the differing portion(s).

FIG. 11 illustrates a display screen format that can be used if a collection of multiple marks on an object is to be recognized. After the marks to be recognized (e.g., four marks on an object) have been entered into the system 10, the exemplary display screen format of FIG. 11 can be used to display the entire collection of entered marks 130, 132, 134, 136. The marks 130-136 in the exemplary display are designated as marks A-D, respectively. The system 10 can be configured to perform a comparison (i.e., a search) to determine which items of archived image information provide the best matches for each of the entered marks 130-136 in the collection. The results then can be displayed simultaneously for all of the entered marks 130, 132, 134, 136, or alternatively, can be displayed sequentially for each of the marks 130, 132, 134, 136.

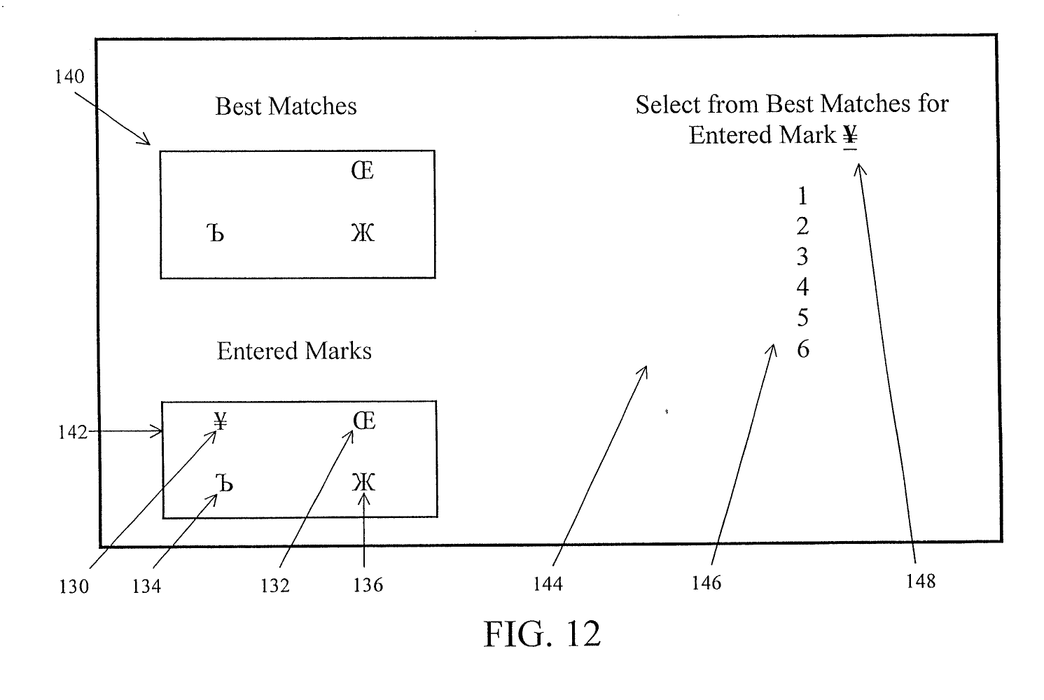

FIG. 12 illustrates an exemplary display screen format that can be used to display the results of a multiple mark search. In FIG. 12, the exemplary screen format includes a “best matches” field 140, an entered marks field 142, and a selection list 144. The best match field 140 preferably includes an image of the closest matching item of archived image information for each of the entered marks 130, 132, 134, 136, except one entered mark (e.g., entered mark 130 in the exemplary display format).

The selection list 144 includes a list 146 of ranking numbers and, preferably by default, an image 148 of the item of archived image information that was determined to be the closest match when the system 10 compared the archived image information to the mark 130 (i.e., the mark that is absent from the “best matches” field 140). There are six ranking numbers in the exemplary screen format of FIG. 12. It is appreciated, however, that the invention can be practiced with more or less than six ranking numbers.

Preferably, each ranking number in the list 146 is selectable by the user (e.g., using a mouse-click, a keyboard entry, touch-screen entry, or the like). The system 10 can be configured to respond to such a selection by replacing the image of the closest match with an image of the correspondingly ranked item of archived image information. Thus, if the number “3” is selected from the list 146, the system 10 preferably responds by replacing the image 148 of the closest match with an image of the third-closest matching item of archived image information. In this manner, the user is provided with a convenient way of switching through and viewing the images of the N-closest matching items of archived image information (where N can be any integer that provides a manageable display format).

When the user visually determines that any particular item in the list 146 is, in fact, the best match, the user can provide the system 10 with a suitable command (e.g., a mouse-click, keyboard entry, touch screen entry, or the like) directing the system 10 to cause an image of that particular item to be displayed in the corresponding portion of the best match field 140. The system 10 preferably is configured to respond to such commands as directed by the user.

Preferably, by default, the system 10 also responds by replacing the image 148 with an image of the item of archived image information that was determined to be the closest match to the mark 132 (i.e., the next one of the entered marks 130, 132, 134, 136), and by associating the ranking numbers in the list 146 with the correspondingly ranked items of archived image information. The ranking this time, however, is based on how close the items of archived image information are to the mark 132.

The system 10 preferably is configured to perform the same selection process for the mark 132 that was performed for the mark 130, as described above. By suitably configuring the system 10, the above process then can be repeated in like manner for the other entered marks 134 and 136.

The foregoing exemplary screen display formats in FIGS. 11 and 12 provide a convenient way of handling situations where objects carry multiple marks. The user advantageously is able to process each of the entered marks, while simultaneously viewing the rest of the entered marks.

The graphic user interface (GUI) 22 also can be configured so that the user is able to customize the display screen format. The user, in this regard, can be presented with prompts, menus, or the like from the GUI 22, in response to which the user can enter instructions that dictate how the GUI 22 will present the result information (i.e. that dictate the display screen format). The prompts, menus, or the like, preferably are user-friendly.

The input module 12 preferably includes an input graphic user interface (IGUI) 170 that facilitates use of the mark recognition system 10 in a user-friendly manner. The IGUI 170 can be configured to present the user with a choice of image input screens (e.g., showing the image being inputted), text input screens, and/or the like. Preferably, one or more of these screens visually present information fields to the user. The information fields preferably are arranged in such a way that they emulate or resemble the GUI 22 associated with the output module 16 (i.e., the GUI that provides the result information). In this regard, there can be a corresponding information field in the IGUI 170 for each display information field provided by the GUI 22 of the output module 16.

Each information field in the IGUI 170 preferably is selectable by the user (e.g., using a “mouse-click” or other selection technique and/or device) and/or can be activated to insert the aforementioned textual information about the mark to be recognized. The processor 14 responds to such entries of information by suitably limiting the aforementioned comparison(s), or performing related functions. Other fields, drop-down menus, pop-up menus, or the like can be provided by the IGUI 170. Drop-down menus are desirable, for example, when entering text information about the materials from which the object is formed, the country of origin of the object, a name or description of the object, and/or the object's date of manufacture.

Such information fields, drop-down menus, pop-up menus, or the like can be selected or otherwise activated by the user to enter commands and/or information for the mark recognition system 10. The processor 14 preferably is configured to respond appropriately to such commands and/or to entries of information.

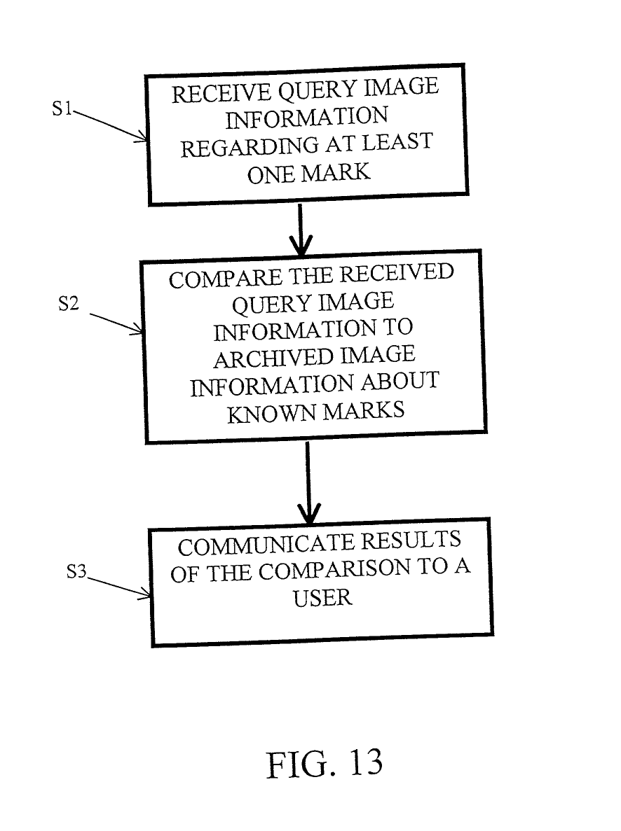

With reference to FIG. 13, the present invention also provides a mark recognition method. This method can be implemented with or without the foregoing exemplary mark recognition system 10. According to a preferred implementation of the method, query image information is received (S1) regarding at least one mark on an object. The query image information preferably is received by capturing an image of the mark(s) to be recognized and digitizing the image to provide a digitized version thereof.

The mark preferably is an indicator of source, such as a hallmark, touch mark, or the like, and the object preferably is a collectible. The received query image information (e.g., the digitized version of a captured image) then is compared (S2) to archived image information about known marks, to determine which one or more items of the archived image information correspond to the query image information. Result information then is communicated (S3) to a user, indicating which of the item(s) of archived image information correspond to the query image information.

Preferably, the method includes determining which item(s) of the archived image information most closely match(es) the query image information, and displaying the item(s) of the archived image information that most closely match(es) the query image information. Preferably, this determination includes ranking of the matches according to how closely the query image information matches each item of archived image information.

The method also can include determining which N items provide a closer match than any other items, where N is an integer greater than zero. The integer N more desirably is greater than 5, and preferably is greater than 10. This determination can be made with or without determining the rank of each such item with respect to the other items within the group of N items. The most closely matching item(s) of archived image information then can be displayed. The most closely matching item(s) preferably is (are) displayed simultaneously with, and adjacent to, the query image information.

The method also can include determining which item in the group of N items matches the query image information better than any of the other items in the group (i.e., which item constitutes a best-match item). The best-match item then can be displayed more prominently than other items in the group of N items. This prominence can be achieved in several different ways. It can be achieved, for example, by providing a larger display of the best-match item and/or by displaying the best-match item closer to a display of the mark that forms the subject of the query image information.

The method also can include selecting a displayed one of the item(s) and displaying an enlarged version of the selected item(s). This enlarged version preferably is presented simultaneously with, and adjacent to, the query image information. This provides a convenient way for the user to visualize the similarities and differences, if any, between the most closely matching item(s). The selection can be made by “mouse-clicking” on the item or via any other convenient selection device and/or technique.

The method also can include visually emphasizing differences, if any, between the query image information and the archived image information. This, as indicated above, is especially desirable when the mark is relatively complex and/or when the differences are subtle. One exemplary way of providing this emphasis is through a highlighting technique. In addition, or alternatively, the desired emphasis can be provided by displaying an enlarged version of any differing portion(s) of the query image information and the archived image information.

Preferably, the communication of result information to a user is performed via a graphic user interface (GUI). The input of query image information also can be facilitated using an input graphic user interface (IGUI).

When determining which items provide the closest match(es), the archived image information can be accessed from one or more databases containing archived image information about known marks and/or about objects that have been associated with such marks. Preferably, the archived image information includes a digitized image of each of the known marks, and is associated with text describing aspects of each known mark. This text can include the name of an object source associated with the known mark, the time period during which the known mark was used by the object source, the geographic area where objects with the known mark were produced or distributed, and/or a description of objects to which the known mark has been applied.

Preferably, the method includes receiving text information about the mark(s) that is (are) the subject of the query image information. The text information can include, for example, the name of an object source associated with the mark(s), a time period during which the mark(s) was (were) used by the object source, a geographic area where objects with the mark(s) were produced or distributed, and/or a description of objects to which the mark(s) has (have) been applied.

The method preferably includes limiting the aforementioned comparison to archived image information about known marks that correspond to the text information. Thus, for example, if the text information indicates that the subject mark was found on an object from England, the comparison to items of archived image information can be limited to archived image information corresponding to known marks that were used in conjunction with objects from England.

When text information is received as indicated above, the communication of result information to the user can be performed so that the result information indicates which of the items (e.g., known marks) of the archived image information correspond to the query image information and also to the text information. Preferably, the result information includes textual information about the known mark(s) associated with the corresponding items of archived image information.

The reception of text information and/or query image information preferably is facilitated by presenting the user with an input graphic user interface (IGUI) that is user-friendly. The IGUI, for example, can be configured to visually display information fields to a user. Each information field preferably is selectable by a user (e.g., using a “mouse-click” or other selection technique and/or device) and/or can be activated to insert the aforementioned textual information about the mark to be recognized. Other fields, drop-down menus, pop-up menus, or the like can be provided by the IGUI. Such information fields, drop-down menus, pop-up menus, or the like can be selected or otherwise activated by the user to enter commands and/or information for use in performing the mark recognition method.

The present invention also can be implemented in the form of a computer-readable medium. More specifically, a computer-readable medium can be encoded with a processor-executable instruction sequence for carrying out the aforementioned method. The computer-readable medium can be provided in the form of one or more machine-readable disks (e.g., magnetic disks or diskettes, compact disks (CDs), DVD disks, or the like), any programmable ROM or RAM (e.g., EEPROM), or the like.

Preferably, the computer-readable medium is encoded so that reading of the medium by a computer establishes the aforementioned mark recognition system 10 on that computer. The mark recognition system 10, in this regard, can be implemented in a stand-alone computer (e.g., with operating software and the database of archived image information being resident on a single PC and/or computer-readable memory associated therewith). By using a lap-top computer or other portable computer, the mark recognition system 10 of the present invention advantageously can be made portable.

To use the resulting mark recognition system, a user provides a digitized image of the mark to be recognized using a suitable image input subsystem, along with any additional information (e.g., the aforementioned text information). The user then provides the suitably configured computer with a search command. The computer responds by implementing the aforementioned instruction sequence and presenting the result information to the user (e.g., a display of the best match or matches with or without a display of the mark to be recognized). The user then can review the result information and either accept the result information, or modify the additional information and execute another search by issuing another search command.

Alternatively, the computer-readable medium can be encoded for network-based operation. The computer-readable medium, in this regard, can be encoded so that reading of the medium by a computer causes the computer to become part of a network-based mark recognition system 10. The communication of image information and text information through such a network-based system can be implemented using any one of the many known techniques for communicating such information. These communication techniques can be implemented with or without data compression algorithms. Exemplary communication techniques are disclosed in U.S. Pat. No. 5,973,731 to Schwab, the contents of which are incorporated herein by reference. It understood that other communication techniques also can be utilized.

The network-based mark recognition system can be provided in several different ways. One way is to provide one or more work stations and a central computer. The central computer can communicate with the work stations using any suitable one of the many well-known communication protocols. Preferably, the reception of query image information (e.g., capturing and digitizing of images of marks) occurs through the work station(s). The query image information then is communicated from the work station(s) to the central computer. At the central computer, the aforementioned comparison and/or accessing of the database of archived information is performed, and the result information is communicated to, and displayed at, the work station(s). The central computer and/or work stations also can be configured to perform additional functions such as ranking, limiting the comparison, and the like.

When providing a work station/central computer configuration, the computer-implemented instruction sequence and/or the database of archived image information can be encoded entirely on a machine-readable medium associated with the central computer. Alternatively, parts of the computer-implemented instruction sequence and/or database of archived image information can be resident on a machine-readable medium associated with one or more of the work stations, or elsewhere on the work station/central computer network.

Another exemplary way to provide a network-based mark recognition system involves use of a client/server computer network (e.g., a local area network LAN, a wide area network WAN, or the like). The computer-readable medium can be encoded so that reading of the medium by a computer causes that computer to operate as a server or a client in the mark recognition system. When operating as a server, a computer performs the aforementioned comparisons and/or accesses the database of archived image information. Computers operating as servers also can perform related functions such as ranking, limiting the comparison, and the like. By contrast, when operating as a client, the computer receives the query image information (e.g., by receiving a captured and/or digitized image of the mark to be recognized, by receiving text information, and/or the like) and provides the user with the result information communicated to the client computer by the computer(s) that operate as servers.

Other network-based configurations of the mark recognition system can be implemented, including but not limited to hybrids of the foregoing exemplary work station/central computer arrangement and exemplary client/server arrangement.

The mark recognition system, computer-readable memory, and/or the mark recognition method also can be implemented in an internet-based manner. The GUIs described above, in this regard, can be implemented using web-browsing techniques and systems. One or more web servers can be used to provide one or more web-sites that are accessed by a user when a mark is to be recognized. The user can transfer a digitized image of the mark to the web-site using any suitable image capturing/communication technique and a suitable internet-based communication method. Text data and other information about a mark to be recognized also can be communicated to the web-site. At the web-site, the aforementioned comparison and any related functions (e.g., ranking, limiting of the comparison, and the like) are performed. The result information then is communicated back to the user that accessed the web-site, preferably via the user's browser. In this exemplary implementation, each user's computer and/or peripheral equipment serves as an input module and an output module. The main processing (e.g., the comparison and related functions), however, is performed by the computers located at the web-site (i.e., at the content provider's facility).

In an alternative internet-based implementation, the user obtains internet access to a web-site and downloads therefrom all or a desired part of the aforementioned computer-implemented instruction sequence and/or all or a desired part of the database of archived image information. The download preferably occurs into a computer-readable medium that is local with respect to the user. By subsequently accessing the local computer-readable medium, the user's computer is able to locally execute the mark recognition method. Updates for the database of archived image information and/or computer-implemented instruction sequence then can be downloaded occasionally or periodically to keep the resulting mark recognition system and method current.

According to yet another exemplary internet-based implementation, the user obtains internet access to a web-site and downloads therefrom all of the aforementioned computer-implemented instruction sequence and none or very little of the database of archived image information. The download preferably occurs into a computer-readable medium that is local with respect to the user. By subsequently accessing the local computer-readable medium, the user's computer is able to locally execute the mark recognition method, while remotely accessing the database of archived image information (e.g., via an internet-based connection).

As the need arises, a content service provider can update the database of archived image information. Updates for the computer-implemented instruction sequence, by contrast, can be downloaded occasionally or periodically to keep the locally resident aspects of the resulting mark recognition system and method current.

The present invention also can be implemented as a hybrid of the foregoing exemplary internet-based implementations, the exemplary network-based implementations, and/or the exemplary stand-alone implementations.

By suitably implementing the foregoing exemplary mark recognition system, mark recognition method, and/or computer-readable medium, the present invention can be configured to provide an automated system and/or method capable of identifying and classifying various types of products or collectibles based on hallmarks, touch marks, or other identifying marks placed thereon or associated therewith by the manufacturer, distributor, or processor of such products, with or without additional information about each such product or collectible. The resulting mark recognition system, mark recognition method, or computer-readable medium can be configured to not only identify the object or collectible but also provide additional information about it.

It thus can be appreciated that the objects of the present invention have been fully and effectively accomplished. It is to be understood that the foregoing specific implementations have been provided to illustrate the functional principles of the present invention and are not intended to be limiting. To the contrary, the present invention is intended to encompass all modifications, substitutions and alterations within the spirit and scope of the appended claims.

It should be noted that limitations of the appended claims have not been phrased in the “means or step for performing a specified function” permitted by 35 U.S.C. §112, ¶6. This is to clearly point out the intent that the claims are not to be interpreted under § 112, ¶6 as being limited solely to the structures, acts and materials disclosed in the present application or the equivalents thereof.

What is claimed is:

1. A mark recognition system comprising:
an input module adapted to receive query image information about at least one mark on an object;
a processor configured to compare the query image information to archived image information about known marks, to determine which one or more items of the archived image information correspond to the query image information; and
an output module configured to communicate, to a user, result information indicating which of said one or more items of the archived image information correspond to the query image information.

2. The mark recognition system of claim 1, wherein said processor is configured to determine which of said one or more items of the archived image information most closely matches said query image information; and
wherein said output module comprises a graphic user interface configured to display the one or more items of the archived image information that most closely match said query image information.

3. The mark recognition system of claim 1, wherein said at least one mark is indicative of a source of the object.

4. The mark recognition system of claim 1, further comprising at least one database containing said archived image information about said known marks, said database being accessible by said processor.

5. The mark recognition system of claim 4, wherein said archived image information includes a digitized image of each of said known marks, said archived image information being associated with text describing aspects of each known mark.

6. The mark recognition system of claim 5, wherein said text includes at least one of:
a name of an object source associated with the known mark;
a time period during which the known mark was used by said object source;
a geographic area where objects with the known mark were produced or distributed; and
a description of objects to which the known mark has been applied.

7. The mark recognition system of claim 1, wherein said input module includes an image capturing device configured to capture an image of said at least one mark and to digitize said image to provide a digitized version of said query image information.

8. The mark recognition system of claim 1, wherein said processor is configured to determine which of said one or more items of the archived image information most closely matches said query image information; and
wherein said output module includes a graphic user interface that is configured to display said query image information and the one or more items of the archived image information that most closely match said query image information.

9. The mark recognition system of claim 8, wherein said graphic user interface is configured to display said query image information simultaneously with, and adjacent to, said one or more items of the archived image information that most closely match said query image information.

10. The mark recognition system of claim 9, wherein said graphic user interface is configured to cooperate with said processor such that, when a user selects a displayed one of said one or more items of the archived image information, an enlarged version of said displayed one of said one or more items is presented by the graphic user interface to the user simultaneously with, and adjacent to, said query image information.

11. The mark recognition system of claim 1, wherein:
said processor is configured to determine which at least five items of the archived image information most closely match said query image information; and
said output module includes a graphic user interface that is configured to display said query image information and said at least five items of the archived image information.

12. The mark recognition system of claim 11, wherein:
said at least five items include one best-match item that matches said query image information better than any of the other items in said at least five items, said processor being configured to determine which of said at least five items constitutes said one best-match item; and
said graphic user interface is further configured to display said best-match item more prominently than others of said at least five items.

13. The mark recognition system of claim 1, wherein:
said input module is configured to receive text information about said at least one mark;
said processor is configured to limit comparison of the query image information to archived image information about known marks that correspond to said text information; and
said output module is configured to communicate, to the user, said result information indicating which of said one or more items of the archived image information correspond to the query image information and to the text information.

14. The mark recognition system of claim 13, wherein said text information includes at least one of:
a name of an object source associated with said at least one mark;
a time period during which said at least one mark was used by said object source;
a geographic area where objects with said at least one mark were produced or distributed; and
a description of objects to which said at least one mark has been applied.

15. The mark recognition system of claim 13, wherein at least one of said output module and said processor is configured so that said result information includes textual information about at least one known mark associated with said at least one item.

16. The mark recognition system of claim 1, wherein at least one of said processor and said output module is configured to visually emphasize differences, if any, between said query image information and the archived image information associated with said one or more items.

17. The mark recognition system of claim 16, wherein at least one of said processor and said output module is configured to display an enlarged version of a portion of said query image information and said archived image information, in which portion said differences, if any, are present.

18. The mark recognition system of claim 1, wherein said input module includes a graphic user interface that is configured to visually display information fields to a user, each information field being selectable by a user to insert textual information about said at least one mark to be recognized.

19. The mark recognition system of claim 18, wherein:
said processor is configured to limit comparison of the query image information to archived information associated with said textual information; and
said output module is configured to communicate, to the user, said result information indicating which of said one or more items of the archived image information correspond to the query image information and also to said textual information.

20. The mark recognition system of claim 19, wherein said textual information includes at least one of:
a name of a n object source associated with said a t least one mark;
a time period during which said at least one mark was used by said object source;
a geographic area where objects with said at least one mark were produced or distributed; and
a description of objects to which said at least one mark has been applied.

21. A mark recognition method comprising:
receiving query image information about at least one mark on an object;
comparing the query image information to archived image information about known marks, to determine which one or more items of the archived image information correspond to the query image information; and
communicating result information to a user, indicating which of said one or more items of the archived image information correspond to the query image information.

22. The mark recognition method of claim 21, further comprising:
determining which of said one or more items of the archived image information most closely matches said query image information; and
displaying the one or more items of the archived image information that most closely match said query image information.

23. The mark recognition method of claim 21, wherein said at least one mark is indicative of a source of the object.

24. The mark recognition method of claim 21, further comprising accessing said archived image information from at least one database containing said archived image information about said known marks.

25. The mark recognition method of claim 24, wherein said archived image information includes a digitized image of each of said known marks, said archived image information being associated with text describing aspects of each known mark.

26. The mark recognition method of claim 25, wherein said text includes at least one of:
a name of an object source associated with the known mark;
a time period during which the known mark was used by said object source;
a geographic area where objects with the known mark were produced or distributed; and
a description of objects to which the known mark has been applied.

27. The mark recognition method of claim 21, further comprising:
capturing an image of said at least one mark and digitizing said image so that said query image information is received as a digitized version of the image.

28. The mark recognition method of claim 21, further comprising:
determining which of said one or more items of the archived image information most closely matches said query image information; and
displaying said query image information and the one or more items of the archived image information that most closely match said query image information.

29. The mark recognition method of claim 28, wherein said query image information is displayed simultaneously with, and adjacent to, said one or more items of the archived image information that most closely match said query image information.

30. The mark recognition method of claim 29, further comprising:
displaying an enlarged version of said displayed one of said one or more items of the archived image information, in response to a user selection of said displayed one of said one or more items, said enlarged version being displayed simultaneously with, and adjacent to, said query image information.

31. The mark recognition method of claim 21, further comprising:
determining which at least five items of the archived image information most closely match said query image information; and
displaying said query image information and said at least five items of the archived image information.

32. The mark recognition method of claim 31, wherein said at least five items include one best-match item that matches said query image information better than any of the other items in said at least five items, further comprising:
determining which of said at least five items constitutes said one best-match item; and
displaying said best-match item more prominently than others of said at least five items.

33. The mark recognition method of claim 21, further comprising:
receiving text information about said at least one mark;
limiting comparison of the query image information to archived image information about known marks that correspond to said text information; and
communicating result information to a user, indicating which of said one or more items of the archived image information correspond to the query image information and to the text information.

34. The mark recognition method of claim 33, wherein said text information includes at least one of:
a name of an object source associated with said at least one mark;
a time period during which said at least one mark was used by said object source;
a geographic area where objects with said at least one mark were produced or distributed; and
a description of objects to which said at least one mark has been applied.

35. The mark recognition method of claim 33, wherein said result information includes textual information about at least one known mark associated with said at least one item.

36. The mark recognition method of claim 21, further comprising:
visually emphasizing differences, if any, between said query image information and the archived image information associated with said one or more items.

37. The mark recognition method of claim 36, further comprising:
displaying an enlarged version of a portion of said query image information and said archived image information, in which portion said differences, if any, are present.

38. The mark recognition method of claim 21, further comprising:
visually displaying information fields to a user, each information field being selectable by a user to insert textual information about said at least one mark to be recognized.

39. The mark recognition method of claim 38, further comprising:
limiting comparison of the query image information to archived information associated with said textual information; and
communicating, to the user, said result information indicating which of said one or more items of the archived image information correspond to the query image information and also to said textual information.

40. The mark recognition method of claim 39, wherein said textual information includes at least one of:
a name of an object source associated with said at least one mark;
a time period during which said at least one mark was used by said object source;
a geographic area where objects with said at least one mark were produced or distributed; and
a description of objects to which said at least one mark has been applied.

41. A computer-readable medium encoded with a processor-executable instruction sequence for:
receiving query image information about at least one mark on an object;
comparing the query image information to archived image information about known marks, to determine which one or more items of the archived image information correspond to the query image information; and
communicating result information to a user, indicating which of said one or more items of the archived image information correspond to the query image information.

42. The computer-readable medium of claim 41, wherein said processor-executable instruction sequence further includes at least one instruction sequence for:
determining which of said one or more items of the archived image information most closely matches said query image information; and
displaying the one or more items of the archived image information that most closely match said query image information.

43. The computer-readable medium of claim 41, wherein said at least one mark is indicative of a source of the object.

44. The computer-readable medium of claim 41, wherein said processor-executable instruction sequence includes at least one instruction sequence for accessing said archived image information from at least one database containing said archived image information about said known marks.

45. The computer-readable medium of claim 44, wherein said archived image information includes a digitized image of each of said known marks, said archived image information being associated with text describing aspects of each known mark.

46. The computer-readable medium of claim 45, wherein said text includes at least one of:
a name of an object source associated with the known mark;
a time period during which the known mark was used by said object source;
a geographic area where objects with the known mark were produced or distributed; and
a description of objects to which the known mark has been applied.

47. The computer-readable medium of claim 41, wherein said processor executable instruction sequence includes at least one instruction sequence for capturing an image of said at least one mark and digitizing said image so that said query image information is received as a digitized version of the image.

48. The computer-readable medium of claim 41, wherein said processor-executable instruction sequence includes at least one instruction sequence for:
determining which of said one or more item s of the archived image information most closely matches said query image information; and
displaying said query image information and the one or more items of the archived image information that most closely match said query image information.

49. The computer-readable medium of claim 48, wherein said query image information is displayed simultaneously with, and adjacent to, said one or more items of the archived image information that most closely match said query image information.

50. The computer-readable medium of claim 49, wherein said processor-executable instruction sequence includes at least one instruction sequence for:
displaying an enlarged version of said displayed one of said one or more items of the archived image information, in response to a user selection of said displayed one of said one or more items, said enlarged version being displayed simultaneously with, and adjacent to, said query image information.

51. The computer-readable medium of claim 41, wherein said processor-executable instruction sequence includes at least one instruction sequence for:
determining which at least five items of the archived image information most closely match said query image information; and
displaying said query image information and said at least five items of the archived image information.

52. The computer-readable medium of claim 51, wherein said at least five items include one best-match item that matches said query image information better than any of the other items in said at least five items, said processor-executable instruction sequence including at least one instruction sequence for:
determining which of said at least five items constitutes said one best-match item; and
displaying said best-match item more prominently than others of said at least five items.

53. The computer-readable medium of claim 41, wherein said processor-executable instruction sequence includes at least one instruction sequence for:
receiving text information about said at least one mark;
limiting comparison of the query image information to archived image information about known marks that correspond to said text information; and
communicating result information to a user, indicating which of said one or more items of the archived image information correspond to the query image information and to the text information.

54. The computer-readable medium of claim 5, wherein said text information includes at least one of:
a name of an object source associated with said at least one mark;
a time period during which said at least one mark was used by said object source;
a geographic area where objects with said at least one mark were produced or distributed; and
a description of objects to which said at least one mark has been applied.

55. The computer-readable medium of claim 53, wherein said result information includes textual information about at least one known mark associated with said at least one item.

56. The computer-readable medium of claim 41, wherein said processor-executable instruction sequence includes at least one instruction sequence for visually emphasizing differences, if any, between said query image information and the archived image information associated with said one or more items.

57. The computer-readable medium of claim 56, wherein said processor-executable instruction sequence includes at least one instruction sequence for displaying an enlarged version of a portion of said query image information and said archived image information, in which portion said differences, if any, are present.

58. The computer-readable medium of claim 41, wherein said processor-executable instruction sequence includes at least one instruction sequence for visually displaying information fields to a user, each information field being selectable by a user to insert textual information about said at least one mark to be recognized.

59. The computer-readable medium of claim 58, wherein said processor-executable instruction sequence includes at least one instruction sequence for:
limiting comparison of the query image information to archived information associated with said textual information; and
communicate, to the user, said result information indicating which of said one or more items of the archived image information correspond to the query image information and also to said textual information.

60. The computer-readable medium of claim 59, wherein said textual information includes at least one of:
a name of an object source associated with said at least one mark;
a time period during which said at least one mark was used by said object source;
a geographic area where objects with said at least one mark were produced or distributed; and
a description of objects to which said at least one mark has been applied.
